(19) United States
(12) Patent Application Publication
(10) Pub. No.: US 2008/0102945 A1
(43) Pub. Date: May 1, 2008

(54) Procedure and dynamic control system and management of gaming machines

(76) Inventor: Miguel Angel Quetglas Arino, Barcelona (ES)

Correspondence Address: Ralph A. Dowell of DOWELL & DOWELL P.C., 2111 Eisenhower Ave, Suite 406, Alexandria, VA, 22314, US

(21) Appl. No.: 11/976,427

(22) Filed: Oct. 24, 2007

(30) Foreign Application Priority Data
Oct. 25, 2006 (ES) 200602783

(51) Int. Cl. G06F 19/00

(52) U.S. Cl. 463/29

(57) ABSTRACT

Procedure which comprises the control and statistical evaluation of the use and collection of each one of the gaming machines (1a, . . . 1n) and the game that they are showing for certain temporal parameters or in real time, determination of the functioning game most in demand, determination of the machines (1j) with the games least in use and/or that are unoccupied, and the changing of the game and rescheduling remotely of one or more of the gaming machines (1j) not in use, according to the statistical result and the situation, for a more demanded game. The system comprises a number of programmable linked gaming machines (1a, . . . 1n), at least one computer (4) connected to a local or global communications network (2a, 6) for the statistical control remotely, at least one storage base (5) for programs of programmable games in the gaming machines (1a, . . . 1n) remotely.

### OBJECT OF THE INVENTION

The present invention refers to a procedure and dynamic system of control and management of gaming machines of the type that comprises one or more communication networks between the above mentioned gaming machines.

### BACKGROUND OF THE INVENTION

The gaming machines installed in an establishment or casino are usually linked by a communications network for management and to share common functions. The play and payout gaming machines like that connected allow the management of an accumulator or common payout of great value that is obtained from all the machines within the establishment. This linked network also allows information of the functionality of each machine to be obtained, such as the time that it has been in use, the amount of money contained in the collection tray, management systems for credit card use or similar and also detection if any machine breaks down.

In document ES2001771 of Máquinas Automáticas Computerizadas, S.A. there is a description of an example of this system by means of a dedicated communication network but which can be extrapolated to any local area network protocol, including conventional networks provided with the relevant security measures. Given that in this system, it is common that the computer or controller that controls various machines can control several machines with one game or with various games.

In search of higher added value and attraction for the client/player, these computers can be linked by means of dedicated communications networks, conventional telecommunications networks or by means of Internet to constitute larger networks of machines in places separated geographically. It is extremely attractive for players to know that they are taking part in winning a large payout shared among a large number of machines in many establishments and that therefore, the value of the payout which can be attained is much higher.

A known patent for example, is patent ES2156727 of Undergaming, S.L., which describes a real time communication system for use in gaming machines, that consists in linking an unlimited number of machines to a local network by means of its own communication software, in conjunction with a network card directly to a hub or controller, which can be fitted with a kit or device, enabling remote connections to other distant networks.

Individually, these gaming machines comprise a set of micro processors in order to function allowing for considerable functioning flexibility. Therefore, with compatible electronics and hardware, according to the program loaded in memory, the same machine can offer the possibility of playing totally different games, changing the concept of the game by simply changing the loaded software. A technician on standby does this task using specific programming tools or physical memory supports, with which it is not advisable to perform the above mentioned change to the machine when the machine is accessible to the public.

Document ES2231367 of Bally Wulff Automaten GMBH describes a procedure and linked gaming machine system which allow a player to play simultaneously on two or more machines in search of a combined payout from both machines, with the possibility of winning an independent payout from each one. This procedure requires the use of a computer or external source which allows the playing of a new game on the same machine without the need of reprogramming of the machine by a technician.

Therefore, it is common that in an arcade or a casino which has various gaming machines, at certain hours those players present will only be playing certain favourite games while the machines with other games are left unused as the games are not considered of interest by those players. The situation can arise where players have to wait their turn to play on already busy machines. This is due to the fact that different users at different times of the day or days of the week have different tastes and preferences, and the casino must have all the games that it offers available more or less simultaneously.

### DESCRIPTION OF THE INVENTION

The procedure and dynamic control system and management of gaming machines of this invention presents some technical particularities designed to obtain a larger yield from the gaming machines installed in arcades and casinos and a higher degree of satisfaction for the user/player.

In effect, the procedure comprises the use of the existing communication systems among the different gaming machines which produce a determined amount of games within a network with a management computer or local controller.

During the use of the different gaming machines and their different games the control and statistical evaluation of the use and collection of each one of the gaming machines and the game that they are currently showing, in real time or according to schedule, for every hour of the day, day of the week and/or other necessary parameters is undertaken.

After this statistical evaluation it is possible to determine which game is most in demand and which offers a larger yield and simultaneously which machines contain the least used games and/or those that are not being used for a prolonged period.

Knowing this information gives the ability to change the game and one or more of the gaming machines out of use, which according to the statistical results can be reprogrammed remotely in real time or for certain times of the day, days of the week or any other necessary situation, loading a game that is statistically more in demand or optionally a different game.

In this way, the set of gaming machines could be adapted to the momentary gaming demands of the users, avoiding machines laying idle for offering games which are not wanted by the present users and thereby gaining a higher degree of customer satisfaction.

The changing of a game within a gaming machine can be undertaken at will by an operator remotely. In this way, new games can be tried or experiments with development solutions, without needing to intervene physically in the machine, can be done.

For the operation of this procedure, the system connects to the programmable gaming machines and linked to a local communications network and at least one management computer or local controller, with the addition of another management computer connected to the local or global communications network for the statistical control of functioning of the gaming machines remotely. This evaluation is undertaken in real time during the functioning of the machines to be able to obtain the most reliable results and the quickest and the most adequate response to the need for change.

The system also comprises a storage base of programmable games programs for the gaming machines, so that each machine can be programmed with one of the existing games, at a distance, from the above mentioned base.

Every gaming machine comprises an added communication module connected to a communication network from which the new programmed game is received. In this way, the channel for the information of the machine's functioning which already exists is kept independent from the programming channel, which requires a larger bandwidth due to the size of the game programming files, whose transfer rates must be quick.

At first, the management computer or local controller and the computer that calculates the need for game changes can be the same device or be integrated to control the network of gaming machines in a particular establishment or casino.

Furthermore, the storage base of games programs can be incorporated in the management computer or local controller to offer integrated functioning. This computer comprises a network card or communication module for its connection to the local gaming machine management network and at least a network card or communication module for the programming of the gaming machines in compliance with that previously mentioned.

In another option, the storage base of games programs is housed in the management and statistical calculation computer which undertakes the changes for centralized functioning. This can be kept away from out of the local gaming machines network. For example, in a remote location, connected to the global network formed by the many local networks of the different establishments and linked casinos. This allows a gaming company, which has machines in various establishments to better manage the licenses of the games that it uses in different establishments.

In order that the gaming machine is able to effectively notify the user/player that a game is available, a mechanism has been foreseen that comprises an additional programmable screen. With the change of a game, the machine changes the name of the available game on the above mentioned screen, which is further able to show game instructions or other user information that is deemed suitable.

### DESCRIPTION OF THE DRAWINGS

To complement the description hereby undertaken and in order to facilitate better understanding of the characteristics of the invention, the present description is accompanied by a set of drawings in which, with illustrative and not limitative character, the following has been represented:

FIG. 1 shows a schematic representation of a machine with a game not in use to another game that is more in demand.

FIG. 2 shows a scheme for installation of both communication networks between machines in an establishment.

FIG. 3 shows a configuration scheme for the linking of different gaming machines.

### PREFERENTIAL EMBODIMENT OF THE INVENTION

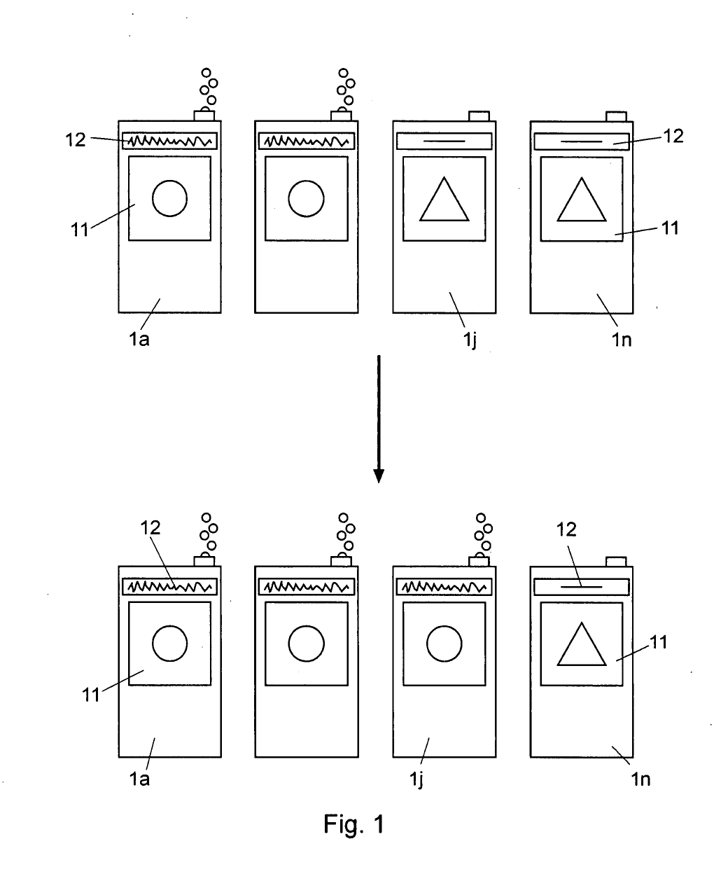

As can be observed in the indexed figures, the system comprises a number of gaming machines (1a, . . . 1n) connected by a network connection (2a) with a management computer (3) or controller that gathers the data on functioning and manages the payouts or incidents. The system further comprises a management computer (4) connected to the various gaming machines (1a, . . . 1n) to receive information of use and collection and yield of the gaming machines (1a, . . . 1n) and a storage base (5) of programs of games that can be sent to a gaming machine (1j) in order that it modifies its functionality according to the demand of the users, hereby represented in the FIG. 1.

Each gaming machine (1a, . . . 1n) contains a game screen (11) and an additional programmable warning screen (12) to show the name and information of the available game.

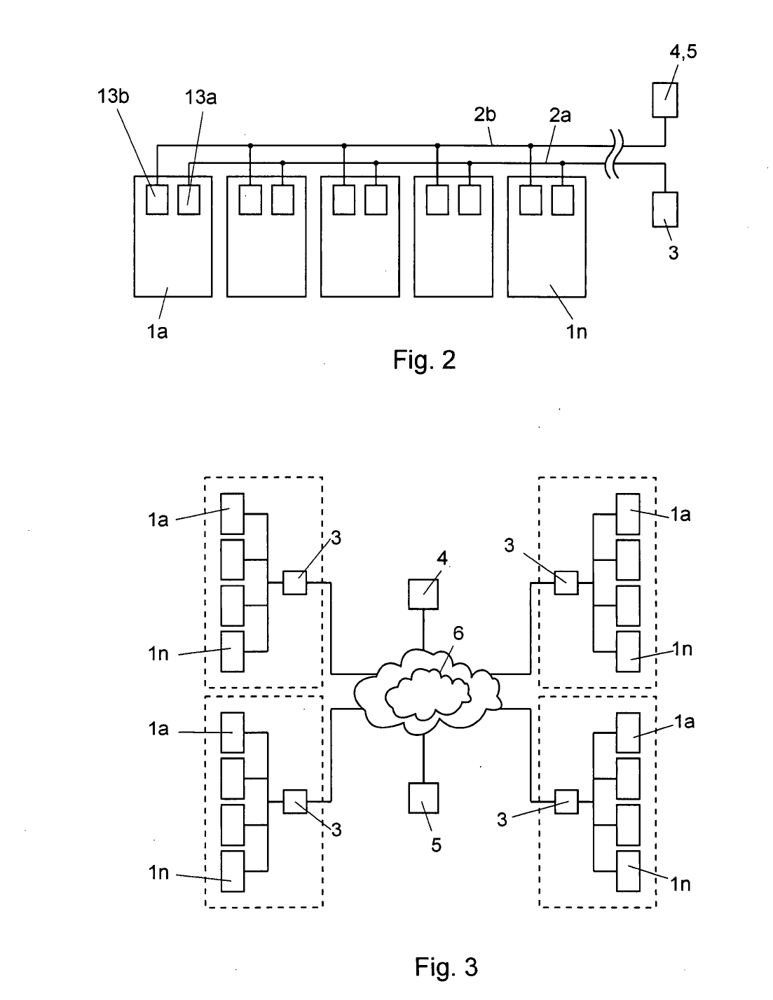

In an example of embodiment represented in FIG. 2, each gaming machine (1a, . . . 1n) comprises two communication modules (13a, 13b) or network cards for the connection of two independent networks (2a, 2b), being connected a network (2a) to the management computer (3) or controller and the other network (2b) to the management computer (4) and the storage base (5) of games simultaneously.

In the second example of embodiment represented in FIG. 3, the gaming machines (1a, . . . 1n) of several establishments are linked by its management computers (3) or respective controllers to a global access computer network or Internet (6) for the communication to the management computer (4) and the storage base (5) of game programs configured remotely. The above mentioned communication is also possible by means of dedicated lines or private virtual networks.

Having sufficiently described the nature of the invention, as well as an example of preferential embodiment, it is hereby certified to any interested party that the materials, form, size and disposition of the described elements can be subject to modification only when this does not suppose an alteration of the essential characteristics of the invention claimed hereafter.

1. Dynamic procedure of control and management of gaming machines which comprises the communication between the different gaming machines (1a, . . . 1n) which generate various games and at least one management computer (3) or local controller, for the variables of functionality evaluation, such as occupation, the collected money, possible breakdowns, and information of collective or independent payouts to be administered and/or other, characterized in that it comprises:
the control and statistical evaluation of the use and collection of each one of the gaming machines (1a, . . . 1n) and the game that they are showing in real time or for each hour of the day, day of the week and/or other necessary parameters,
determination of the game most in demand of the functioning gaming machines (1a, . . . 1n),
determination of the machines (1j) with the games least in use and/or that are unoccupied,
changing of the game and rescheduling remotely of one or more of the gaming machines (1j) not in use, according to the statistical result in real time or by hour of the day, day of the week or any another necessary situation, for a statistically more demanded game or optionally a different game.

2. Procedure, according to the claim 1, characterized in that the change is undertaken at will by an operator remotely.

3. System, of the type that comprises a number of programmable gaming machines (1a, . . . 1n) linked by at least one local communication network (2a) and at least one management computer (3) or local controller placed in a specific location, this management computer (3) having the capacity to be connected to a network of global access computers such as Internet (6) or a dedicated communication network with other management computers (3) of other establishments to function in conjunction, characterized in that it comprises:
at least one management computer (4) connected to a local or global communications network (2a, 6) for the statistical control of functioning of the gaming machines (1a, . . . 1n) remotely,
at least one storage base (5) for programs of programmable games in the gaming machines (1a, . . . 1n) remotely.

4. System, according to claim 3, characterized in that each gaming machine (1a, . . . 1n) comprises an additional communication module (13b) connected to a communication network (2b) through which the program of the new game is received.

5. System, according to claim 3, characterized in that the management computer (3) or local controller and the management computer (4) are the same device.

6. System, according to any of claims 3 and 4, characterized in that the base storage base (5) of games programs is incorporated in the management computer (3) or local controller, including a network card or communication module for its connection to the local gaming machine management network (2a) and at least one network card or communication module for connection to the gaming machine programming network (2b).

7. System, according to claim 3, characterized in that the storage base (5) of programs of games is housed in the management computer (4).

8. System, according to claim 3, characterized in that the management computer (4) is in a remote location connected to the global net or Internet (6).

9. System, according to claim 3, characterized in that the storage base (5) of games programs is in a remote location connected to the global net or Internet (6).

10. System, according to claim 3, characterized in that each gaming machine (1a, . . . 1n) comprises an additional programmable warning screen (12) for the showing of the name and additional information of the available game.
